(19) United States
(12) Patent Application Publication
(10) Pub. No.: US 2010/0085743 A1
(43) Pub. Date: Apr. 8, 2010

(54) MEMORIAL CROSS

(76) Inventor: Steven M. Franklin, Scottsboro, AL (US)

Correspondence Address: LITMAN LAW OFFICES, LTD., POST OFFICE BOX 41200, SOUTH STATION, ARLINGTON, VA, 22204, US

(21) Appl. No.: 12/309,481

(22) PCT Filed: Jul. 17, 2007
(86) PCT No.: PCT/US07/16134

§ 371 Date: Oct. 5, 2009

Related U.S. Application Data
(60) Provisional application No. 60/831,683, filed on Jul. 19, 2006.

(51) Int. Cl. F21L 4/02; H01J 9/24

(52) U.S. Cl. 362/183; 445/23

(57) ABSTRACT

The memorial cross (105) provides night-time illumination of a translucent cruciform housing. Photovoltaic solar panels (120) on the housing's upwardly facing surfaces charge internal electrical batteries (205) during daylight hours. At dusk, a control switch directs current from the charged batteries (105) to light emitting diodes (LEDs) (210) that are disposed in the vertical (115) and horizontal (110) sections of the housing so that the LEDs (210) emit light through the translucent cruciform housing. Decorative images (including flags, illustrations, indicia, etc.) may be displayed on the face of the cruciform housing.

### TECHNICAL FIELD

The present invention relates to decorative markers, and more particularly to a commemorative illuminated cross.

### BACKGROUND ART

There are many types of decorative markers that are designed for use in graveyards, memorial services, and the like. Illuminated crucifixes are used for these occasions, as well. Well known illuminated crucifixes may have a single light disposed within a translucent cruciform structure. However currently available illuminated crucifixes require an attendant to turn the device off at times when it would be inappropriate to be illuminated.

Commonly available illuminated crucifixes require an externally furnished power source. Power is generally supplied either from a power grid electrical power cable, or from batteries that are either non-rechargeable, or batteries that must be removed from the decorative crucifix to be recharged. Currently available devices are also difficult to maintain in outdoor conditions because the external housing cannot be sealed.

Further, in cases where it is desired to memorialize the loss of a loved one on a highway, the roadside use of the device should be effective in that the device should be highly visible. However, the device must not be distracting to drivers on the road, nor should the device present a hazard to those who must maintain it.

The need exists for an illuminated crucifix that requires little or no maintenance and is easily visible at night. The current invention provides a virtually maintenance-free crucifix illuminated by light emitting diodes and powered by a solar power system.

### DISCLOSURE OF INVENTION

The disclosure is directed to a memorial cross. The cross has a hollow translucent vertical section that is joined with a hollow translucent horizontal section to form a cruciform shaped housing. Photovoltaic solar panels are mounted on the top surfaces of the horizontal and vertical sections. A plurality of light sources and batteries are mounted within at least one of the cruciform sections. A control switch disposed within the cruciform housing is electrically operationally coupled to the batteries, the light sources, and the photovoltaic solar panels. A removable one piece cover panel is attached to the rear of the cruciform housing via fasteners that are disposed on edges. The cruciform shape of the one piece panel matches the shape of the hollow vertical and horizontal sections of the cruciform housing. Removable mounting bosses are disposed on the one piece cover so that the cross can be mounted for display by mating the mounting bosses with mounting points on a mounting device.

At dawn, the control switch switches the batteries from operating the lighting sources to a charging mode so that the photovoltaic solar panels charge the batteries. Conversely, at dusk, the control switch switches the batteries away from the photovoltaic solar panels and back to power the lighting sources, whereby the memorial cross becomes illuminated.

The current invention is also directed to a system for providing an illuminated memorial cross apparatus. The system includes a housing means. The housing means is a translucent polymeric cruciform housing with a single vertical section, and first and second horizontal sections that extend perpendicularly from the vertical section. The vertical section has a single upwardly oriented square photovoltaic solar panel. The first and second horizontal sections each have a single upwardly oriented rectangular photovoltaic solar panel. The square photovoltaic solar panel is oriented between the rectangular photovoltaic solar panels so that square photovoltaic solar panel and the rectangular photovoltaic solar panels comprise the entire upwardly facing surface of the housing. The square photovoltaic solar panel is disposed parallel to, but in a separate horizontal plane from, the rectangular solar photovoltaic panels.

The system also includes an illuminating means. The illuminating means utilizes at least three batteries. Two of the batteries are longitudinally mounted in the housings's vertical section, and one battery is mounted in a central region formed by an intersection of the vertical section and the two horizontal sections. The batteries are in electrical communication with the square and rectangular photovoltaic solar panels. The illuminating means also includes at least four light emitting diodes (LEDs). A first LED is positioned adjacent a first end of the vertical section, and a second positioned LED adjacent a second end of the vertical section. A third LED is positioned adjacent a first end of the first horizontal section, and a fourth LED positioned adjacent a first end of the second horizontal section. All four of the LEDs are in electrical communication with the batteries. A control switch is operationally coupled to the square and rectangular photovoltaic panels, the batteries, and the LEDs. During daylight hours the control switch directs current generated by the photovoltaic panels to the batteries, and at dusk the control switch directs the current from the batteries to the LEDs.

In operation, the illuminating means is positioned within the housing means so that light is projected through the housing means thereby providing the illuminated memorial cross apparatus of the current invention.

The current invention is also directed to a method of making an illuminated cross. A translucent horizontal housing is combined with a translucent vertical housing to form a translucent cross. Photovoltaic solar panels are attached to the upwardly facing surfaces of the cross. Electrical batteries and light sources are installed in the cross. The batteries are connected to the photovoltaic solar panels and the light sources. A control switch is installed in the cross and connected to the batteries and the photovoltaic solar panels. During daylight hours the control switch directs electrical current from the photovoltaic solar panels to the batteries. At night the control switch directs electrical current from the batteries to the light sources so that the light sources project light through the horizontal and vertical housings and thereby illuminates the cross.

### BRIEF DESCRIPTION OF THE DRAWINGS

FIG. 1 is an environmental, perspective view of a memorial cross according to the present invention.

FIG. 2 is a top, cutaway top view of the memorial cross, according to the present invention.

FIG. 3 is a side, cutaway side view of the memorial cross, according to the present invention.

FIG. 4 is a schematic diagram of the memorial cross.

### BEST MODES FOR CARRYING OUT THE INVENTION

The memorial cross provides night-time illumination at a memorial site. Translucent vertical and horizontal sections form a cruciform shaped housing. A plurality of light emitting diodes (LEDs) are disposed at several positions inside the housing. A power source comprises a plurality of batteries. The batteries are mounted within the housing and are operationally coupled to the LEDs via a control switch. The control switch is also operationally coupled to solar panels disposed on upper surfaces of the horizontal and vertical sections. At dawn, the control circuit switches the batteries from operating the lights to a charging mode connection with the photovoltaic solar panels. At dusk, the control circuit switches the batteries away from the photovoltaic solar panels and back to power the LEDs which illuminate the translucent memorial cross from within. Decorative designs such as flags, names, faces, religious symbols and other indicia may be displayed on the face of the cross. The cross may be of any color or combination of colors desired. For example, an American flag may be displayed across the horizontal or vertical section of the housing.

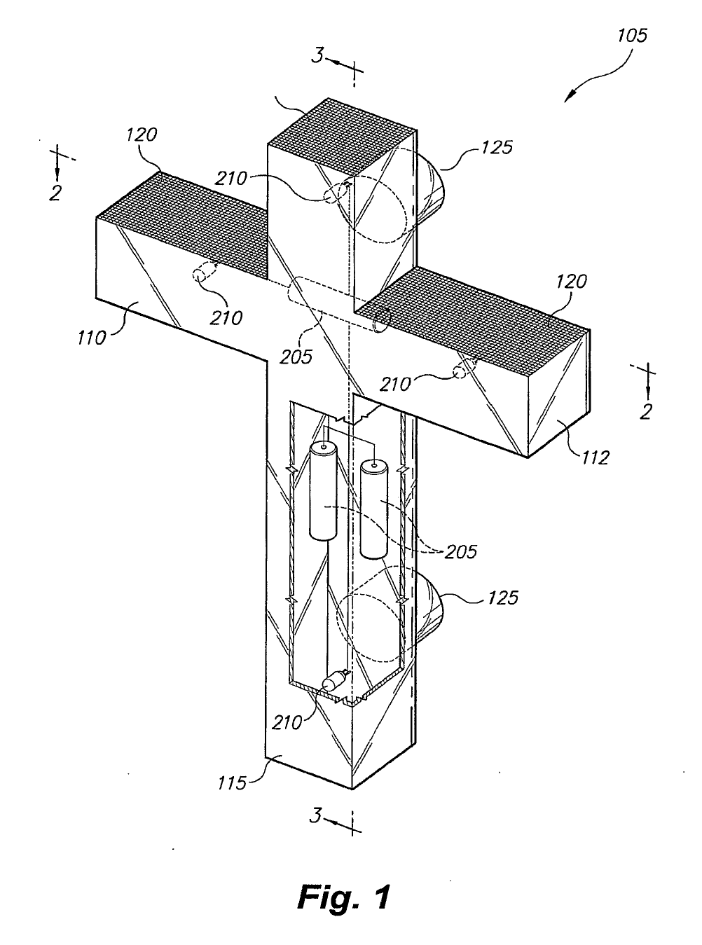

As shown in FIG. 1, the memorial cross 105 of the present invention can provide a substantially continual night-time illumination at a memorial site. The illuminated memorial cross 105 includes a cruciform shaped translucent housing. The housing is formed by hollow vertical 115 and horizontal 110 sections having closed ends 112. The hollow vertical section 115 and horizontal section 110 may be formed of one piece of translucent material, such as e.g., a preferably durable, weather-resistant, translucent polymer.

Alternatively, the vertical section 115 and the horizontal section 110 may be separate pieces, with, for example, the vertical section 115 having slots, i.e., apertures, through which the horizontal section 110 may be fitted and locked into place. In a further alternative the housing may be divided into a single vertical section and first and second horizontal sections extending parallel to the vertical section.

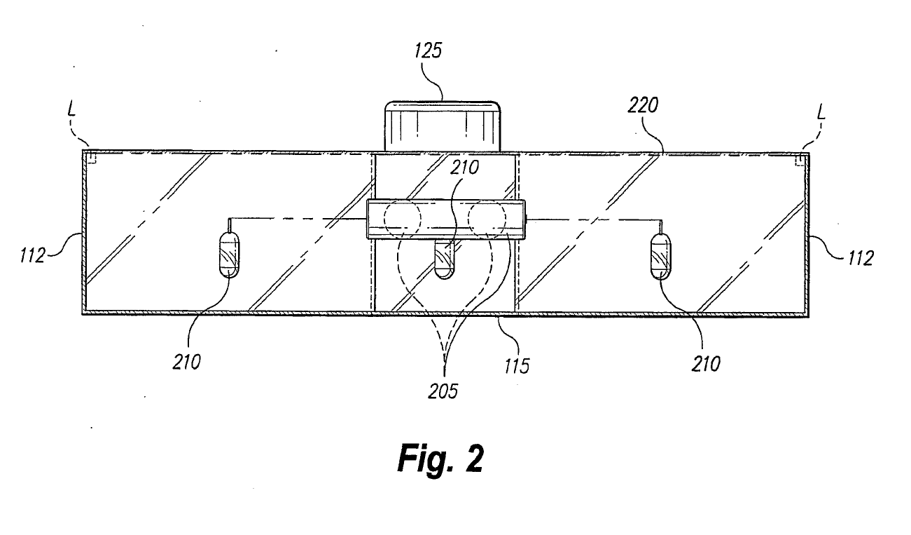

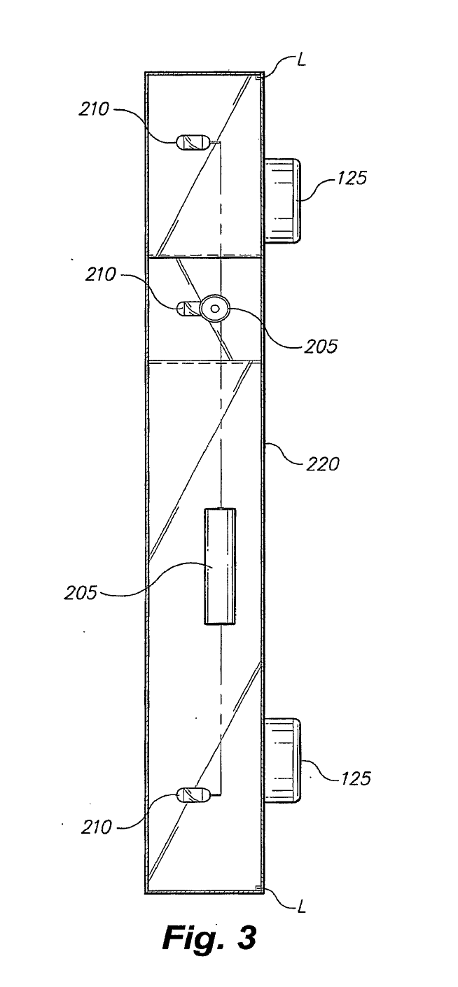

Electronic components, such as a plurality of LEDs 210 or other illuminating sources, and batteries 205, may be mounted inside the hollow openings of either the vertical section 115 or the horizontal section 110, or both sections. As shown in FIGS. 2 and 3, a one piece cover panel 220 having a cruciform shape that matches the hollow opening presented at the rear of the vertical 115 and horizontal 110 sections of the memorial cross 105 provides a protective cover for the rear of the unit and can be removably attached via fasteners disposed along the edge of the cover panel 220, e.g. snap fit latches L.

As shown in FIGS. 1-3, cylindrical bosses 125 are disposed on the cover panel 220 near a top of the cover panel 220 and near a bottom of the cover panel 220. The cylindrical bosses 125 are provided so that the memorial cross 105 can be mounted for display by mating the cylindrical bosses 125 with corresponding mounting points, e.g., sleeve, collar, aperture, and the like, on a mounting surface or stand (not shown).

The light sources, which preferably include the plurality of LEDs 210, are disposed at several positions inside the translucent housing. As shown in FIG. 1, two LEDs 210 are disposed within the horizontal section 110 on opposing sides of the horizontal section 110. An additional two LEDs 210 are disposed within the vertical section 115, one LED 210 being proximate the bottom end of vertical section 115, the remaining LED 210 being proximate the top end of vertical section 115. A power source which preferably comprises the batteries 205 may be mounted in the vertical section 115 as well as the horizontal section 110 and are operationally coupled to the LEDs 210. As shown in FIG. 1, two batteries 205 are longitudinally mounted within the vertical section 115. A third battery is laterally mounted in a central hollow region formed by the intersection of vertical section 115 and horizontal section 110.

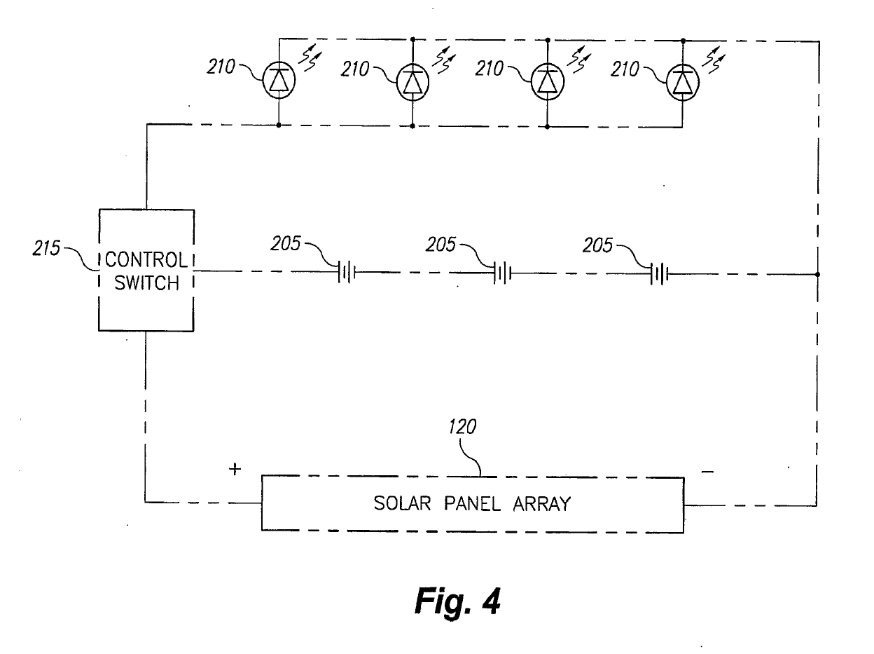

As shown in FIG. 4, an electrical control switch 215 is provided. The electrical control switch may be disposed within the memorial cross 105. The electrical control switch 215 is operationally coupled to the batteries 205, and light sources 210, and well as solar panels 120 disposed on the horizontal 110 and vertical 115 sections of the housing.

The solar panels 120 are comprised of a plurality of photovoltaic solar cells. As best shown in FIG. 1, the solar panels 120 are disposed on upper surfaces of the horizontal 110 and vertical 115 sections so that the solar panels 120 comprise the entire upwardly facing surface of the housing, thereby maximizing solar exposure without negatively impacting the horizontally-facing potentially decorative surfaces of the housing. The solar panels 120 are configured so that the generally square solar panels 120 on the vertical section 115 are disposed parallel with, but in a different horizontal plane than the generally rectangular solar panels 120 on the horizontal section 110.

The control switch 215, being operationally coupled to the solar panels 120, lights 210 and batteries 205, has the capability to switch battery electrical power off from the lights 210 contemporaneously with switching solar electrical power developed by the solar panels 120 to charge the batteries 205 during daylight hours. At dusk, the control switch 215 operates in reverse to switch the batteries 205 away from the solar panels 120 and back to power the LEDs 210. When the LEDs 210 are powered by the batteries 205 at night, the memorial cross becomes illuminated, being highly visible, though non-glaring, due to the translucent characteristics of the vertical section 115 and the horizontal section 110 of the memorial cross 105. Decorative designs such as flags, names, faces, religious symbols and other indicia may be displayed on the face of the cross. The cross may be of any color or combination of colors desired. For example, an American flag may be displayed across the horizontal or vertical section of the housing.

It is to be understood that the present invention is not limited to the embodiment described above, but encompasses any and all embodiments within the scope of the following claims.

1. A memorial cross, comprising:
a hollow translucent vertical section joined with a hollow translucent horizontal section to form a cruciform shaped housing;
photovoltaic solar panels mounted on top surfaces of the horizontal and the vertical sections;
batteries mounted within at least one of the horizontal or vertical sections;
a plurality of light sources mounted within at least one of the horizontal or vertical sections;
a control switch disposed within the cruciform housing, the control switch being electrically operationally coupled to the batteries, the light sources, and the photovoltaic solar panels;
a one piece cover panel having fasteners disposed on edges of a cruciform shape that matches the hollow vertical and horizontal sections of the cruciform housing, the one piece cover being removably attached to the cruciform housing via the fasteners;
mounting bosses being disposed on the one piece cover so that the memorial cross can be mounted for display by mating the mounting bosses with corresponding mounting points on a mounting device; and,
wherein at dawn, the control switch switches the batteries from operating the lighting sources to a charging mode to charge the batteries via a connection with the photovoltaic solar panels, and at dusk, the control switch switches the batteries away from the photovoltaic solar panels and back to power the lighting sources, whereby the memorial cross becomes illuminated.

2. The memorial cross of claim 1 wherein the horizontal and vertical sections are formed of one piece of translucent material.

3. The memorial cross of claim 2 wherein the translucent material comprises a polymer.

4. The memorial cross of claim 1 wherein the horizontal section is formed of one piece of translucent polymer and the vertical section is formed of one piece of translucent polymer, the vertical section having slots through which the horizontal section engages the vertical section so that the horizontal section locks into the vertical section.

5. The memorial cross of claim 1 wherein the light sources and the batteries are disposed in both the horizontal section and the vertical section.

6. The memorial cross of claim 1 wherein the light sources, batteries and control switch are disposed in only one of the horizontal section or the vertical section.

7. The memorial cross of claim 1 wherein the mounting bosses are cylindrical and extend normal to the one piece cover.

8. The memorial cross of claim 1 wherein the photovoltaic solar panel on the horizontal section extends parallel to the photovoltaic solar panel on the vertical section.

9. The memorial cross of claim 8 wherein the photovoltaic solar panel on the horizontal section extends in a different plane than the photovoltaic solar panel on the vertical section.

10. The memorial cross of claim 1 wherein the photovoltaic solar panels comprise:
a single square photovoltaic solar panel on the vertical section; and
two rectangular photovoltaic solar panels on the horizontal section.

11. The memorial cross of claim 1 wherein the batteries comprise at least three batteries.

12. The memorial cross of claim 11 wherein the batteries comprise two batteries mounted longitudinally in the vertical section and one battery mounted laterally in a central region formed by an intersection of the vertical section and the horizontal section.

13. The memorial cross of claim 1 wherein the light sources are comprised of light emitting diodes (LEDs).

14. The memorial cross of claim 13 wherein the light source is comprised of four LEDs,
a first LED is positioned adjacent a first end of the vertical section,
a second LED is positioned adjacent a second end of the vertical section,
a third LED is positioned adjacent a first end of the horizontal section, and
a fourth LED is positioned adjacent a second end of the horizontal section.

15. The memorial cross of claim 1 wherein a decorative design is displayed on a face of the housing.

16. The memorial cross of claim 15 wherein the decorative design is a flag.

17. A system for providing an illuminated memorial cross apparatus, the system comprising:
a housing means comprising:
a translucent polymeric cruciform housing having a single vertical section, and first and second horizontal sections extending perpendicularly from the vertical section, wherein:
the vertical section comprises a single upwardly oriented square photovoltaic solar panel; and
the first and second horizontal sections each comprise a single upwardly oriented rectangular photovoltaic solar panel;
wherein the square photovoltaic solar panel is oriented between the rectangular photovoltaic solar panels so that square photovoltaic solar panel and the rectangular photovoltaic solar panels comprise the entire upwardly facing surface of the housing, the square photovoltaic solar panel being disposed parallel to, but in a separate horizontal plane from, the rectangular solar photovoltaic panels;
an illuminating means comprising:
at least three batteries, two batteries being longitudinally mounted in the vertical section and one battery being mounted in a central region formed by an intersection of the vertical section and the first and second horizontal sections, the batteries being in electrical communication with the square and rectangular photovoltaic solar panels;
at least four light emitting diodes (LEDs), a first LED positioned adjacent a first end of the vertical section, and a second LED positioned adjacent a second end of the vertical section, a third LED positioned adjacent a first end of the first horizontal section, and a fourth LED positioned adjacent a first end of the second horizontal section, the LEDs being in electrical communication with the batteries; and
a control switch, the control switch being operationally coupled to the square and the rectangular photovoltaic panels, the batteries, and the LEDs, so that during daylight hours the control switch directs current generated by the square and rectangular photovoltaic panels to the batteries, and at dusk the control switch directs current from the batteries to the LEDs;
wherein the illuminating means is positioned within the housing means so that light is projected through the housing means thereby providing an illuminated memorial cross apparatus.

18. A method of making an illuminated cross, the steps comprising:
providing a vertical translucent housing;
fitting a translucent horizontal housing into the translucent vertical housing so that the horizontal housing in combination with the vertical housing forms a translucent cross;
attaching photovoltaic solar panels to upwardly facing surfaces of the cross;
installing electrical batteries in the cross and connecting the batteries to the photovoltaic solar panels;
installing light sources in the cross and connecting the light sources to the batteries; and,
installing a control switch in the cross and connecting the control switch to the batteries and the photovoltaic solar panels so that during daylight hours the control switch directs electrical current from the photovoltaic solar panels to the batteries, and at night the control switch directs electrical current from the batteries to the light sources so that the light sources project light through the horizontal and vertical housings and thereby illuminate the cross.
